(19) United States
(12) Patent Application Publication
(10) Pub. No.: US 2003/0191720 A1
(43) Pub. Date: Oct. 9, 2003

(54) Electronic tracking tag

(76) Inventor: Himgan Wibisono, San Francisco, CA (US)

Correspondence Address: Sheryl Sue Holloway, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/404,641

(22) Filed: Mar. 31, 2003

Related U.S. Application Data
(60) Provisional application No. 60/371,181, filed on Apr. 8, 2002.

(51) Int. Cl. H04K 1/00

(52) U.S. Cl. 705/54

(57) ABSTRACT

An electronic tag for content distributed within a peer-to-peer network is created. The tag comprises credits for allocation among peers based on transactional data that tracks the distribution of the content. The tag is associated with the content. In one aspect, the credits are allocated based on the transactional data.

### RELATED APPLICATIONS

This application is related to and claims the benefit of U.S. Provisional Patent Application No. 60/371,181 entitled “DRM Coupon,” filed Apr. 8, 2002, which is herein incorporated by reference.

### FIELD OF THE INVENTION

This invention relates generally to electronic distribution of digital content, and more particularly to distribution of content associated with an electronic tracking tag within a peer-to-peer network.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2003, Sony Electronics, Inc., All Rights Reserved.

### BACKGROUND OF THE INVENTION

The recent widespread use of peer-to-peer applications, such as Gnutella and Napster, indicates the potential benefits of effectively distributing digital content through peer-to-peer (P2P) networks. A P2P network is typically one in which any node on the network may function as both a client and a server. For example, Napster enabled peer-to-peer file sharing by means of direct TCP/IP port-to-port connections. In addition, Napster delivered data by means of the hypertext transfer protocol (HTTP), the same protocol that many web browsers and servers utilize. Thus, effectively, each computer connected to the network acted as a server and as a client.

One of the benefits of P2P networking is efficient content distribution. However, in order for the P2P network to function optimally, there should be a balance between users who share content (“sharers”) and users who take content (“takers”). In many current P2P networks, there is little incentive for a user to share content with other users on the network, since typically a user may freely obtain content from other users on the network without having to share content in return.

### SUMMARY OF THE INVENTION

An electronic tag for content distributed within a peer-to-peer network is created. The tag comprises credits for allocation among peers based on transactional data that tracks the distribution of the content. The tag is associated with the content. In one aspect, the credits are allocated based on the transactional data.

### BRIEF DESCRIPTION OF THE DRAWINGS

FIG. 1A is a diagram illustrating a system-level overview of an embodiment of the invention;

FIGS. 1B, 1C and 1D are diagrams of environments suitable for practicing the invention; and

FIGS. 2A and 2B are flow diagrams of methods to be performed by a computer according to embodiments of the invention.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

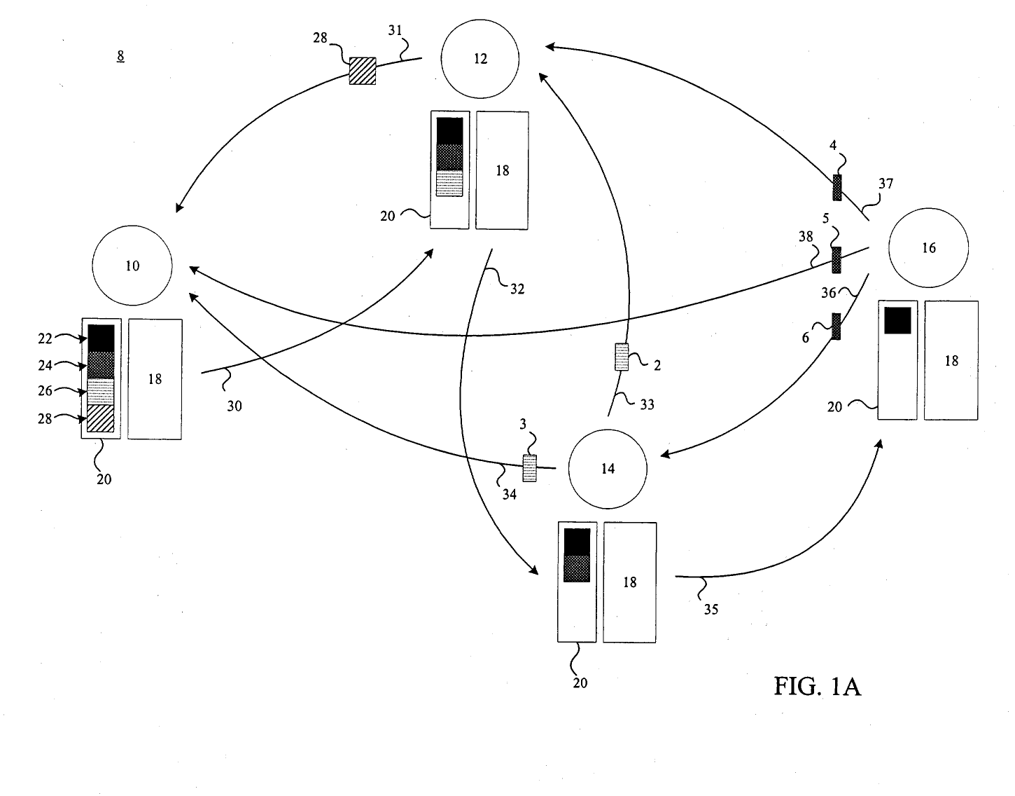

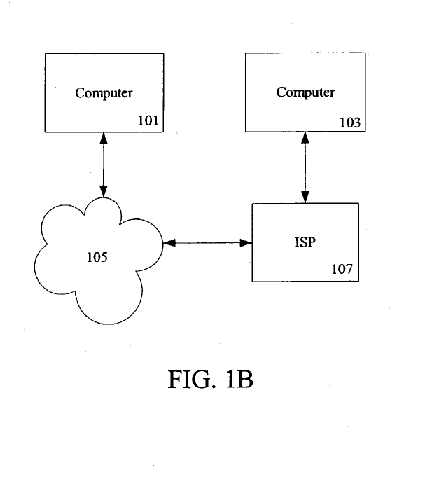

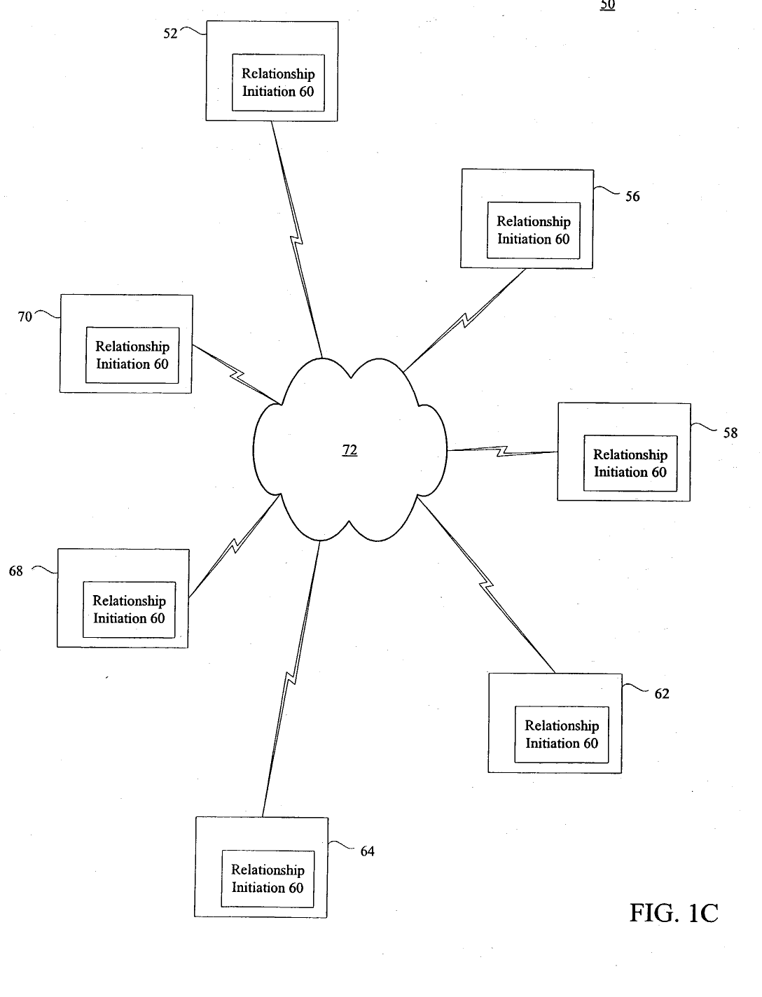

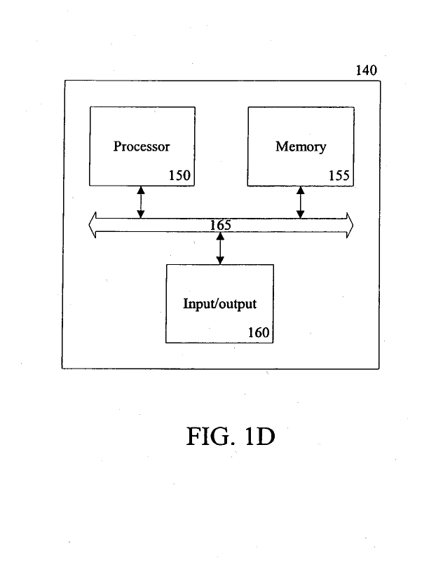

A system level overview of the operation of an embodiment of the invention is described with reference to FIG. 1A. Distribution of content associated with an electronic tracking tag within a peer-to-peer network is described. Distribution system 8 includes nodes 10, 12, 14, 16, content 18, electronic tracking tag 20, and credits 22, 24, 26, 28. Nodes 10, 12, 14, 16 are connection points. In one embodiment, each node 10, 12, 14, 16 serves as a client, a server, or both, as described below in conjunction with FIG. 1C. In another embodiment, each node 10, 12, 14, 16 is any of a personal computer, a handheld computer, or other computing device, as described below in conjunction with FIG. 1D. In yet another embodiment, each node 10, 12, 14, 16 represents a different user of a network. Content 18 is any digital information which may be shared over a network. In one embodiment, content 18 includes data, audio, video or other media. In an embodiment, content 18 is a music file, such as for example an MPEG Audio Layer 3 (MP3) file. Content 18 is associated with an electronic tracking tag 20. For simplicity, content 18 which is associated with an electronic tracking tag 20 may be referred to as tagged content. Also, for simplicity, an electronic tracking tag may be referred to as a tag. In one embodiment, tag 20 includes meta-data appended to content 18 which serves as an identifier to allow content 18 to be tracked as it is distributed among nodes 10, 12, 14, 16. Credits 22, 24, 26, 28 are associated with tag 20. In other embodiments, more or less credits may be associated with tag 20. Credits 22, 24, 26, 28 are allocated among nodes 10, 12, 14, 16 as content 18 is distributed between nodes 10, 12, 14, 16. In an embodiment, credits 22, 24, 26, 28 are received for sharing content. For example, in one embodiment, credits 22, 24, 26, 28 are redeemable for price discounts or access to additional content.

In one embodiment, a user at node 10 makes content 18 available for sharing with other users of a network. Movement of content and credits is illustrated in FIG. 1A through arrows 30, 31, 32, 33, 34, 35, 36, 37 and 38. When content 18 is distributed (arrow 30) from node 10 to node 12, credit 28 is allocated (arrow 31) to node 10. The allocation of credit 28 may depend on the occurrence of a qualifying event. A qualifying event may be distribution (e.g. sharing), use or purchase of content 18. Other qualifying events may trigger allocation of credit 28.

In one embodiment, credit 28 is allocated to node 10 upon the occurrence of a qualifying event at node 12. For example, the qualifying event at node 12 may be a purchase or use of content 18 at node 12. In another embodiment, credit 28 is allocated to node 10 when content 18 is made available for sharing by node 10. In yet another embodiment, credit 28 is allocated to node 10 when content 18 is distributed to node 12.

In one embodiment, after allocating credit 28 to node 10 upon a qualifying event at node 12, there are fewer credits associated with tag 20. Once content 18 is distributed to node 12, node 12 may distribute content 18 to other nodes.

Credits 24, 26, 28 are allocated based on subsequent distribution of content 18. For example, in one embodiment, when content 18 is subsequently distributed (arrow 32) from node 12 to node 14, a portion 2 of credit 26 is allocated (arrow 33) to node 12 upon the occurrence of a qualifying event at node 14. Additionally, in one embodiment, a portion 3 of credit 26 is allocated (arrow 34) to node 10 upon the occurrence of a qualifying event at node 14. In this manner, node 10 may receive additional credits based on subsequent distribution of content 18. In one embodiment, when a qualifying event has not yet occurred at node 12, an allocation of credit to node 10, e.g. a portion 3 of credit 26, is triggered by a qualifying event at node 14.

Similarly, node 14 may further distribute (arrow 35) content 18 to node 16. A portion 6 of credit 24 is allocated (arrow 36) to node 14 upon the occurrence of a qualifying event at node 16. Additionally, a portion 4 of credit 24 is allocated (arrow 37) to node 12 upon the occurrence of a qualifying event at node 16. In one embodiment, a portion 5 of credit 24 is also allocated (arrow 38) to node 10 upon the occurrence of a qualifying event at node 16.

In one embodiment, as shown in FIG. 1B, a computer 101 is part of, or coupled to a network 105, such as the Internet, to exchange data with another computer 103, as either a client or a server computer. For example, in one embodiment, node 10 of FIG. 1A is a computer 101 and is part of, or coupled to a network 105 to exchange data with other computers 103. Typically, a computer couples to the Internet through an ISP (Internet Service Provider) 107 and executes a conventional Internet browsing application to exchange data with a server. Other types of applications allow clients to exchange data through the network 105 without using a server. It is readily apparent that the present invention is not limited to use with the Internet; directly coupled and private networks are also contemplated.

For instance, in one embodiment, nodes 10, 12, 14 and 16 of FIG. 1A are computers coupled together in a peer-to-peer network such as illustrated in FIG. 1C. FIG. 1C illustrates one embodiment of a peer-to-peer network environment 50 that is layered on top of a standard network 72, such as a Wide-Area Network (WAN) or a Local-Area Network (LAN). Each device node connected to the network 72 may be logically coupled through the network 72 to any of the other nodes on the network 72 to form the peer-to-peer network environment 50. Each node may correspond to one or more physical devices. As illustrated, the peer-to-peer network environment 50 includes device 52, device 56, device 58, device 62, device 64, device 68, and device 70. Each device is at least capable of performing peer-to-peer communications with the other devices functioning as peers in the network environment 50. Peer-to-peer communications includes the sharing of computer resources and services by direct exchange between peer devices (or indirectly though an intermediate peer device). These resources and services may include the exchange of information, processing cycles, cache storage, and disk storage for files, among other examples, although all of the resources and services are not required to be present on each peer device. Therefore, each device 52, 56, 58, 62, 64, 68, and 70 in the network 50 may initiate a peer-to-peer communications session in the network environment 50.

Each device also has the capability of identifying devices it would like to communicate or initiate a relationship with, to discover devices entering and leaving the network environment 50 (discovery process), and to determine what communications protocol is being used in the network environment 50. For example, communication between peer devices may be via a wire and/or wireless protocol, such as TCP/IP, Real Time Streaming Protocol (RTSP), Bluetooth, 802.11x protocols commonly referred to as WiFi (Wireless Fidelity), and WAP (Wireless Application Protocol) used to exchange data across mobile telephone networks, among other communication protocols well known in the art.

The devices 52, 56, 58, 62, 64, 68, and 70 may include mobile devices such as a personal digital assistance (PDA), a mobile phone, a portable computer, a pager, a portable music player (e.g., an MP3 player), among other devices. Alternatively, the devices 52, 56, 58, 62, 64, 68, and 70 may include typical non-mobile devices, such as a desktop computer, a home entertainment system, a set-top box, a gaming system, among other examples. An embodiment of a suitable device is described below in conjunction with FIG. 1D.

It will be appreciated that the peer-to-peer network environment 50 illustrated in FIG. 1C does not limit the configuration of peer-to-peer networks in which tagged content may be distributed. For example, one of skill will readily appreciate that a server may be coupled to the peer-to-peer network to provide centralized services to the peer devices. Furthermore, one of skill in the art will immediately understand that more than one peer-to-peer network environment may be layered on the same underlying network structure and that each peer device may participate in multiple peer-to-peer network environments simultaneously.

Each device 52, 56, 58, 62, 64, 68, and 70 also includes relationship initiation software 60 that facilitates the creation, sharing, modifying, and deletion of persona information, as will be described. Persona information may reflect the personality, behaviors, habits, and personal interests of a user of each device. For example, the persona information for a user of a device may include a set of attributes such as, an artist list, a song list, a favorite song list, a favorite artist list, rating of users, comments on songs, interest list (e.g., vegetarian, chess player, etc), among other attributes that relate to the user of a device. Those of ordinary skill in the art will recognize that numerous attributes may be used and the invention is not limited to only those described herein.

In one embodiment, persona information associated with a user of a device is automatically collected. For example, a list of interests of a user of the device 52 may be automatically generated by recording the web sites the user visits, the music the user listens to, the films the user watches, etc. The persona information may be stored as public and private persona information relating to the user of the device.

The relationship initiation software 60 on each device 52, 56, 58, 62, 64, 68, and 70 also allows the user of each device to initiate a relationship and store persona information from one or more of the other users of the devices on the network. For example, a user may seek to initiate a relationship with another user by initiating a conversation (e.g., querying others for a restaurant recommendation, initiating an instant messaging session, etc.), to share digital content of common interest (e.g., music, poetry, literature, films, pictures, etc.), etc. Furthermore, depending on the type of relationship that is generated between the users, a level of trust may be built and visually displayed. For example, in one embodiment, distribution of content 18 from node 12 to node 14 occurs as a result of relationship initiation software 60 on nodes 12 and 14.

One embodiment of a system suitable for use in the environments of FIGS. 1B-C is illustrated in FIG. 1D. The system 140 includes a processor 150, memory 155 and input/output capability 160 coupled to a system bus 165. The memory 155 is configured to store instructions which, when executed by the processor 150, perform the methods described herein. The memory 155 may also store data, such as content 18 of FIG. 1A. In one embodiment, the memory 155 stores credits 22, 24, 26, 28. Additionally, the memory 155 may store transactional data. Transactional data is data related to the content 18, such as data relating to the occurrence of a qualifying event and distribution of the content. Input/output 160 provides for the delivery and display of the data such as content 18 or portions or representations thereof. Input/output 160 also encompasses various types of machine or computer-readable media, including any type of storage device that is accessible by the processor 150. One of skill in the art will immediately recognize that the term “computer-readable medium/media” or “machine-readable medium/media” further encompasses a carrier wave that encodes a data signal. It will also be appreciated that the computer is controlled by operating system software executing in memory 155. Input/output and related media 160 store the machine/computer-executable instructions for the operating system and methods of the present invention as well as the data such as content 18.

The description of FIGS. 1B-D is intended to provide an overview of computer hardware and various operating environments suitable for implementing the invention, but is not intended to limit the applicable environments. It will be appreciated that the system 140 is one example of many possible devices that have different architectures. A typical device will usually include at least a processor, memory, and a bus coupling the memory to the processor. Such a configuration encompasses personal computer systems, network computers, television based systems, such as Web TVs or set-top boxes, handheld devices, such as cell phones, portable media devices, personal digital assistants, and similar devices. One of skill in the art will immediately appreciate that the invention can be practiced with other system configurations, including multiprocessor systems, minicomputers, mainframe computers, and the like. The invention can also be practiced in distributed computing environments where tasks are performed by remote processing devices that are linked through a communications network.

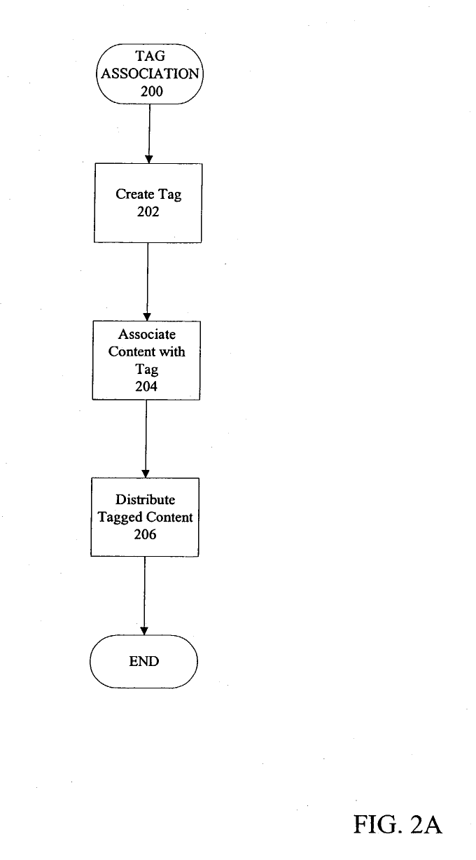

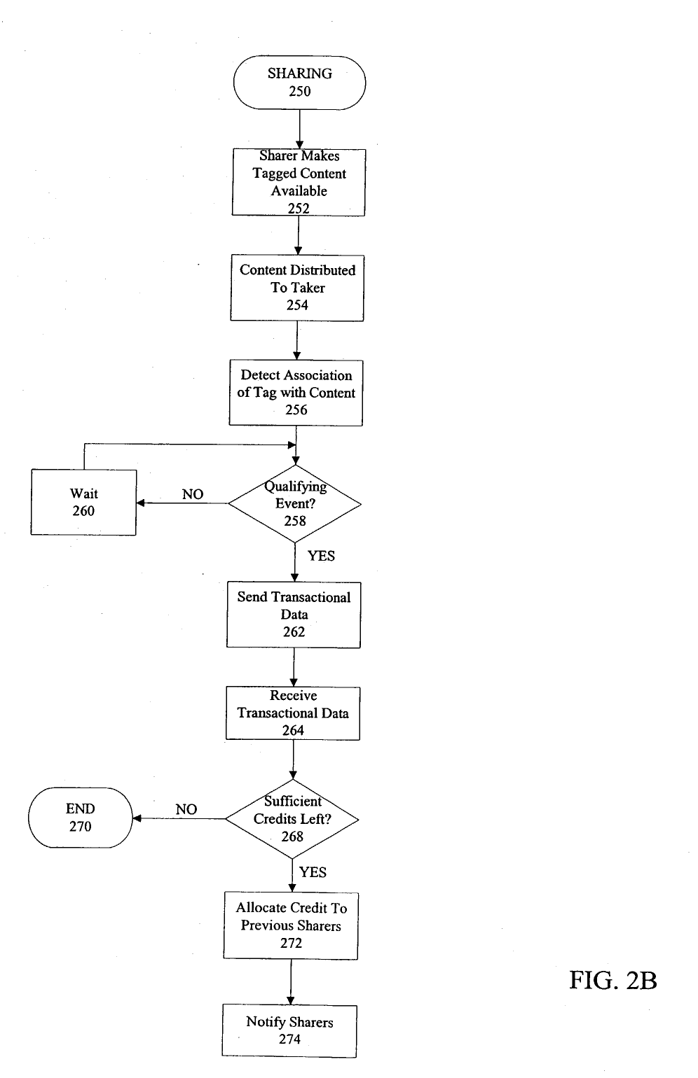

The particular methods of the invention are described in terms of computer software with reference to a series of flow diagrams. FIG. 2A illustrates a flow diagram of one embodiment of a method that associates content 18 with tag 20, shown in FIG. 1A. In one embodiment, the method 200 illustrated by FIG. 2A is performed by a content provider's device. FIG. 2B illustrates a flow diagram of one embodiment of a method 250 that allocates credits 22, 24, 26, 28, shown in FIG. 1A. In one embodiment, the method 250 illustrated by FIG. 2B is performed at least in part by a sharer's device, a taker's device and a credit provider's device. In another embodiment, the method 250 illustrated by FIG. 2B is performed by a peer application running on a user's device. In yet another embodiment, the method illustrated by FIG. 2B is performed by a central server that tracks content and allocates credits. The methods 200 and 250 constitute computer programs made up of computer-executable instructions illustrated as blocks (acts) from 200 until 274 in FIGS. 2A and 2B. Describing the methods by reference to a flow diagram enables one skilled in the art to develop such programs including such instructions to carry out the methods on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer processes may be incorporated into the methods illustrated in FIGS. 2A and 2B without departing from the scope of the invention and that no particular order is implied by the arrangement of blocks shown and described herein.

Referring first to FIG. 2A, an embodiment of the acts to be performed by a processor executing the tag association method 200 are shown. At block 202, a content provider, or an entity that will redeem the tag, creates a tag. In one embodiment, a tag includes a data file storing transactional data. The tag is also used to generate additional transactional data through tracking of the content. In an embodiment, the tag is updated with transactional data as the content is distributed. Transactional data related to the content may include information about distribution, purchases, and use of the content, as well as other information related to the content and the users which it has been distributed to. In one embodiment, transactional data includes information related to the persona of users through which the content is distributed. Credits are associated with the tag. In an embodiment, credits are allocated to users for sharing content. In one embodiment, the tag may be similar to a coupon, since credits are associated with the tag, which are allocated to users for sharing content.

At block 204, the content provider associates content with the tag. Once the content is associated with the tag, the content may be referred to as tagged content. In an embodiment, the tag is part of meta-data appended to the content. The meta-data includes transactional data. In another embodiment, the meta-data includes a logical link, such as a pointer, which specifies the location of transactional data external to the meta-data. For example, in an embodiment, the meta-data is a uniform resource locator (URL) which defines a route to a file in a database which includes the transactional data. In such an embodiment, the transactional data is stored on a server. In another embodiment, the server storing transactional data is operated by a credit provider. At block 206, the content provider distributes the tagged content. In one embodiment, the content provider distributes the tagged content to a user after a purchase of the content.

Referring to FIG. 2B, an embodiment of the acts to be performed by a processor executing the sharing method 250 are shown. At block 252, a sharer's device on a P2P network makes the tagged content available for distribution on the P2P network. It will be appreciated that the initial sharer may obtain the tagged content through well-known distribution mechanisms for digital content. At block 254, the sharer's device distributes the content to a taker on the P2P network. In one embodiment, a taker actively initiates a transfer of the content from the sharer. In another embodiment, a transfer of content is initiated by the taker's device in response to receiving a recommendation from another user, or in yet another embodiment, based on either of the sharer's or the taker's persona. At block 256, the taker's device detects that the content is associated with a tag. In one embodiment, an application on the taker's device detects the associated tag by reading meta-data appended to the tagged content. At decision block 258, the taker's device determines whether a qualifying event has occurred. In one embodiment, a qualifying event is a purchase. In another embodiment, a qualifying event is a use of the content. For example, if the content is a music file, such as an MP3 file, a qualifying event may occur when a taker listens to the music. In yet another embodiment, a qualifying event is the distribution of the content to the taker or to subsequent takers. If the taker's device determines that a qualifying event has not occurred, the sharing method 250 waits at block 260 until a qualifying event occurs.

If the taker's device determines at block 258 that a qualifying event has occurred, then the taker's device sends transactional data associated with the content at block 262 to a credit provider. At block 264, the credit provider receives the transactional data. In one embodiment, a central server receives the transactional data. The central server stores and analyzes transactional data associated with the content. For example, the central server may be operated by the credit provider, or by the operator of a P2P file sharing network.

At decision block 268, the credit provider determines whether there are sufficient credits left to allocate to previous sharers of the content. In one embodiment, the credit provider determines the amount of credits available based on the transactional data associated with the content. In an embodiment, the meta-data includes a pointer which points to a data file storing the number of credits remaining. If the credit provider determines at decision block 268 that there are not sufficient credits to allocate, then the sharing method 250 ends at block 270. In one embodiment, if there are not sufficient credits to allocate, the content remains associated with the tag, so that transactional data related to the content may still be stored.

If the credit provider determines that there are sufficient credits to allocate, then at block 272 credits are allocated to previous sharers of the content, and the number of remaining credits is updated. In an embodiment, as previously described, credits are allocated based on the distribution chain which led to the distribution of the content to the current taker. At block 274, the credit provider notifies sharers of the distribution of the credits.

It will be appreciated that a taker may subsequently become a sharer of the content by making the content available to other takers at block 252. In one embodiment, when a taker subsequently becomes a new sharer of the content, a new electronic tracking tag is created and associated with the subsequently shared content. In an embodiment, the newly created tag stores transactional data related to the distribution of the content from the new sharer (previous taker). In another embodiment, the newly created tag is linked to previous tags for the content, so that the entire distribution history and transactional data relating to the content is maintained. In another embodiment, credits are allocated based on the entire distribution history of the content.

Although the method 250 illustrated in FIG. 2B is described above with respect to a taker's device, a sharer's device, and a credit provider, method 250 may be implemented in alternative ways. For example, in one embodiment, the sharing method 250 of FIG. 2B is implemented through a peer application running on a user's device, in which a qualifying event involving the content occurring on the user's device triggers the application to search for all users that the particular content had passed through, and distribute credits accordingly. In one embodiment, the peer application also calculates the reduction in credits. The peer application may also provide a report of credit allocation to all users through which the content has been distributed.

In another embodiment, the sharing method 250 of FIG. 2B is implemented through a combination of server and peer based applications, in which each qualifying event involving the content is recorded by a central server. In one embodiment, a qualifying event triggers a peer application to notify a central server of the qualifying event. The central server then handles the calculation and allocation of credits, as well as storing transactional data.

In one embodiment, an electronic tracking tag is used in conjunction with a digital rights management system. For example, transactional data generated based on tagged content may be used to account for royalties paid to content providers or authors of content.

Distribution of tagged content within a peer to peer network has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

While the invention is not limited to any particular implementation, for sake of clarity a simplified system level overview of the operation of an embodiment of the invention has been described with reference to FIG. 1A. For example, those of ordinary skill within the art will appreciate that nodes 10, 12, 14, 16 may be part of a local network, a wide area network, or may represent dispersed users on the Internet. Furthermore, the terminology used in this application with respect to credit is meant to include discounts for purchases of content, as well as other incentives. Therefore, it is manifestly intended that this invention be limited only by the following claims and equivalents thereof.

What is claimed is:

1. A computerized method comprising:
creating an electronic tag for content distributed within a peer-to-peer network, wherein the tag comprises credits for allocation among peers based on transactional data that tracks the distribution of the content; and
associating the tag with the content.

2. The computerized method of claim 1, further comprising:
receiving the content at a peer;
detecting that the tag is associated with the content; and
sending the transactional data upon an occurrence of a qualifying event at the peer.

3. The computerized method of claim 2, wherein the qualifying event is a distribution, a use or a purchase.

4. The computerized method of claim 1, further comprising:
receiving the transactional data from a peer; and
allocating the credits based on the transactional data.

5. The computerized method of claim 1, wherein the transactional data is distribution data, usage data, or sales data.

6. A computerized method comprising:
receiving content associated with an electronic tag at a peer, wherein the tag comprises credits for allocation among peers based on transactional data that tracks the distribution of the content;
detecting that the tag is associated with the content; and
sending the transactional data upon an occurrence of a qualifying event at the peer.

7. The computerized method of claim 6, wherein the transactional data is distribution data, usage data, or sales data.

8. The computerized method of claim 6, wherein the qualifying event is a distribution, a use, or a purchase.

9. The computerized method of claim 6, further comprising:
receiving the transactional data; and
allocating credits among peers based on the transactional data.

10. A machine-readable medium having executable instructions to a cause a device to perform a method comprising:
creating an electronic tag for content distributed within a peer-to-peer network, wherein the tag comprises credits for allocation among peers based on transactional data that tracks the distribution of the content; and
associating the tag with the content.

11. The machine-readable medium of claim 10, wherein the method further comprises:
receiving the content at a peer;
detecting that the tag is associated with the content; and
sending the transactional data upon an occurrence of a qualifying event at the peer.

12. The machine-readable medium of claim 11, wherein the qualifying event is a distribution, a use or a purchase.

13. The machine-readable medium of claim 10, wherein the method further comprises:
receiving the transactional data from a peer; and
allocating the credits based on the transactional data.

14. The machine-readable medium of claim 10, wherein the transactional data is distribution data, usage data, or sales data.

15. A machine-readable medium having executable instructions to a cause a device to perform a method comprising:
receiving content associated with an electronic tag at a peer, wherein the tag comprises credits for allocation among peers based on transactional data that tracks the distribution of the content;
detecting that the tag is associated with the content; and
sending the transactional data upon an occurrence of a qualifying event at the peer.

16. The machine-readable medium of claim 15, wherein the transactional data is distribution data, usage data, or sales data.

17. The machine-readable medium of claim 15, wherein the qualifying event is a distribution, a use, or a purchase.

18. The machine-readable medium of claim 15, wherein the method further comprises:
receiving the transactional data; and
allocating credits among peers based on the transactional data.

19. A system comprising:
a processor coupled to a memory through a bus; and
a system process executed by the processor from the memory to cause the processor to create an electronic tag for content distributed within a peer-to-peer network, and associate the tag with the content, wherein the tag comprises credits for allocation among peers based on transactional data that tracks the distribution of the content.

20. The system of claim 19, wherein the system process executed by the processor from the memory further causes the processor to receive the content at a peer, detect that the tag is associated with the content, and send the transactional data upon an occurrence of a qualifying event at the peer.

21. The system of claim 20, wherein the qualifying event is a distribution, a use or a purchase.

22. The system of claim 19, wherein the system process executed by the processor from the memory further causes the processor to receive the transactional data from a peer, and allocate the credits based on the transactional data.

23. The system of claim 19, wherein the transactional data is distribution data, usage data, or sales data.

24. A system comprising:
a processor coupled to a memory through a bus; and
a system process executed by the processor from the memory to cause the processor to receive content associated with an electronic tag at a peer, detect that the tag is associated with the content, and send the transactional data upon an occurrence of a qualifying event at the peer, wherein the tag comprises credits for allocation among peers based on transactional data that tracks the distribution of the content.

25. The system of claim 24, wherein the transactional data is distribution data, usage data, or sales data.

26. The system of claim 24, wherein the qualifying event is a distribution, a use, or a purchase.

27. The system of claim 24, wherein the system process executed by the processor from the memory further causes the processor to receive the transactional data, and allocate credits among peers based on the transactional data.

28. An apparatus comprising:
means for creating an electronic tag for content distributed within a peer-to-peer network, wherein the tag comprises credits for allocation among peers based on transactional data that tracks the distribution of the content; and
means for associating the tag with the content.

29. The apparatus of claim 28, comprising:
means for receiving the content at a peer;
means for detecting that the tag is associated with the content; and
means for sending the transactional data upon an occurrence of a qualifying event at the peer.

30. The apparatus of claim 29, wherein the qualifying event is a distribution, a use or a purchase.

31. The apparatus of claim 28, comprising:
means for receiving the transactional data from a peer; and
means for allocating the credits based on the transactional data.

32. The apparatus of claim 28, wherein the transactional data is distribution data, usage data, or sales data.

33. An apparatus comprising:
means for receiving content associated with an electronic tag at a peer, wherein the tag comprises credits for allocation among peers based on transactional data that tracks the distribution of the content;
means for detecting that the tag is associated with the content; and
means for sending the transactional data upon an occurrence of a qualifying event at the peer.

34. The apparatus of claim 33, wherein the transactional data is distribution data, usage data, or sales data.

35. The apparatus of claim 33, wherein the qualifying event is a distribution, a use, or a purchase.

36. The apparatus of claim 33, comprising:
means for receiving the transactional data; and
means for allocating credits among peers based on the transactional data.
